(19) United States
(12) Patent Application Publication
(10) Pub. No.: US 2010/0125501 A1
(43) Pub. Date: May 20, 2010

(54) APPARATUS AND METHOD FOR PROVIDING AND RECEIVING MOBILE ADVERTISING SERVICE IN A MOBILE ADVERTISING SYSTEM

(75) Inventors: Seok-Hoon CHOI, Seongnam-si (KR); Hae-Young Jun, Anyang-si (KR); Ji-Hye Lee, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/615,017

(22) Filed: Nov. 9, 2009

(30) Foreign Application Priority Data
Nov. 14, 2008 (KR) 10-2008-0113506

(51) Int. Cl. G06Q 30/00

(52) U.S. Cl. 705/14.52; 705/14.49; 705/14.67

(57) ABSTRACT

A method and apparatus is provided for providing a mobile advertising service in an advertising server of a mobile advertising system. An advertisement request message and contextualization and personalization information is received from an advertising engine. An advertisement corresponding to the contextualization and personalization information is selected. The selected advertisement and the contextualization and personalization information used to select the advertisement is delivered to the advertising engine.

### PRIORITY

This application claims priority under 35 U.S.C. §119(a) to a Korean Patent Application filed in the Korean Intellectual Property Office on Nov. 14, 2008 and assigned Serial No. 10-2008-0113506, the entire disclosure of which is incorporated herein by reference.

### BACKGROUND OF THE INVENTION

1. Field of the Invention

The present invention relates generally to a mobile advertising system, and more particularly, to an apparatus and method for providing and receiving mobile advertising services in a mobile advertising system.

2. Description of the Related Art

The mobile communication market continuously requires creation of new services through recombination or integration of existing technologies. Current development of communication and broadcast technologies has enabled conventional broadcasting systems and mobile communication systems to provide advertising services through portable terminals (or mobile terminals), such as mobile phones and Personal Digital Assistants (PDAs).

Due to latent and actual market needs and increasing user demand for multimedia services, service provider intended strategies for providing new services, such as advertising services, in addition to the existing voice service and data service, and the identified interests of Information Technology (IT) companies, which are bolstering their mobile communication businesses to meet user demands, convergence of a mobile communication service and an Internet Protocol (IP) has become a priority in the development of next generation mobile communication technologies.

Open Mobile Alliance (OMA), a group studying a standard for interworking between individual mobile solutions, are currently defining various application standards for mobile games, Internet services, etc. Of the OMA working groups, Open Mobile Alliance Requirement (OMA REQ) Working Group and Open Mobile Alliance Content Delivery (OMA CD) Working Group are researching a technology standard for offering Mobile Advertising (MobAd) services.

A mobile advertising system includes an Advertising (Ad) Engine and an Ad Server. The Ad Engine and the Ad Server request and provide an advertisement, respectively, by referencing or using (hereinafter referred to as “referencing/using”) Contextualization and Personalization Information (hereinafter referred to as “C & P information”) in order to provide personalized advertising services to users. In some cases, however, the Ad Server may select and provide an advertisement by referencing/using C & P information that is different from C & P information that the Ad Engine sent with an advertisement request, e.g., when there is no advertisement corresponding to the C & P information the Ad Engine sent with the advertisement request, or when dynamic/static information is changed by a user between the time the Ad Engine requested an advertisement and the time the Ad Server actually selects an advertisement.

The Ad Engine sends a request for an advertisement to the Ad Server based on a keyword (e.g., restaurant). Then the Ad Server selects an advertisement corresponding to the keyword and added C & P information (e.g., location (Santa Barbara)), and delivers the selected advertisement to the Ad Engine. At this point, the Ad Server does not deliver the C & P information (e.g., location (Santa Barbara)) to the Ad Engine. Even though the user may be located in another location (e.g., Las Vegas) later on, if the Ad Engine sends a request for the advertisement with the same keyword (e.g., restaurant) using an Advertising Application (Ad App), the Ad Server delivers the same advertisement as the previous one to the Ad Engine, i.e., the advertisement for the restaurant in Santa Barbara, without considering the current location, i.e., Las Vegas.

### SUMMARY OF THE INVENTION

The present invention is designed to address at least the above-mentioned problems and/or disadvantages occurring in the prior art and to provide at least the advantages described below.

Accordingly, an aspect of the present invention is to provide an apparatus and method for enabling an Ad Engine to receive an advertisement and C & P information that an Ad Server actually referenced/used during its advertisement selection, to prevent the Ad Server from referencing/using C & P information that is different from the C & P information that the Ad Engine sent with an advertisement request.

Another aspect of the present invention is to provide an apparatus and method for delivering C & P information used during advertisement selection with an advertisement, when receiving an advertisement requested by an Ad Engine and providing the advertisement to a user through an advertising application.

In accordance with an aspect of the present invention, there is provided a method for providing a mobile advertising service in an Ad Server of a mobile advertising system. The method includes receiving an advertisement request message and contextualization and personalization information from an Ad Engine; selecting an advertisement corresponding to the contextualization and personalization information; and delivering the selected advertisement and the contextualization and personalization information to the Ad Engine.

In accordance with another aspect of the present invention, there is provided a method for providing a mobile advertising service in an Ad Server of a mobile advertising system. The method includes receiving an advertisement request message and contextualization and personalization information from an Ad Engine; determining whether there is an advertisement corresponding to the contextualization and personalization information; acquiring new contextualization and personalization information from a contextualization and personalization resource unit, when there is no advertisement appropriate for the received contextualization and personalization information; selecting an advertisement corresponding to the new contextualization and personalization information received from the Ad Engine and the acquired contextualization and personalization information; and delivering the selected advertisement and the contextualization and personalization information to the Ad Engine.

Other aspects, advantages, and salient features of the present invention will become apparent to those skilled in the art from the following detailed description, which, taken in conjunction with the annexed drawings, discloses various embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a mobile advertising system and interfaces between respective entities, according to an embodiment of the present invention;

FIG. 2 illustrates a detailed block diagram of a terminal and an Ad Server as illustrated in FIG. 1, according to an embodiment of the present invention;

FIG. 3 is a flow diagram illustrating a method for providing and receiving a mobile advertising service in a mobile advertising system according to an embodiment of the present invention;

FIG. 4 is a flow diagram illustrating a method for providing and receiving a mobile advertising service in a mobile advertising system according to an embodiment of the present invention;

FIG. 5 is a flow diagram illustrating a method for providing and receiving a mobile advertising service in a mobile advertising system according to an embodiment of the present invention;

FIG. 6 is a flow diagram illustrating a method for providing and receiving a mobile advertising service in a mobile advertising system according to an embodiment of the present invention; and

FIG. 7 is a flow diagram illustrating a method for providing and receiving a mobile advertising service in a mobile advertising system according to an embodiment of the present invention.

Throughout the drawings, the same drawing reference numerals will be understood to refer to the same elements, features, and structures.

### DETAILED DESCRIPTION OF EMBODIMENTS OF THE INVENTION

The matters defined in the description, such as a detailed construction and elements, are provided to assist in a comprehensive understanding of certain embodiments of the present invention. Accordingly, those of ordinary skill in the art will recognize that various changes and modifications of these embodiments can be made without departing from the scope and spirit of the present invention. Also, descriptions of well-known functions and constructions are omitted for clarity and conciseness.

Although the embodiments of the present invention described below will be presented using names of entities defined by 3^{rd} Generation Partnership Project (3GPP), which is a 3^{rd} generation mobile communication standard, or by MobAd of Open Mobile Alliance (OMA), which is a standard group providing applications for mobile terminals, the standards and entity names are not intended to limit the scope of the present invention, and the present invention may be applied to any other systems having similar technical backgrounds.

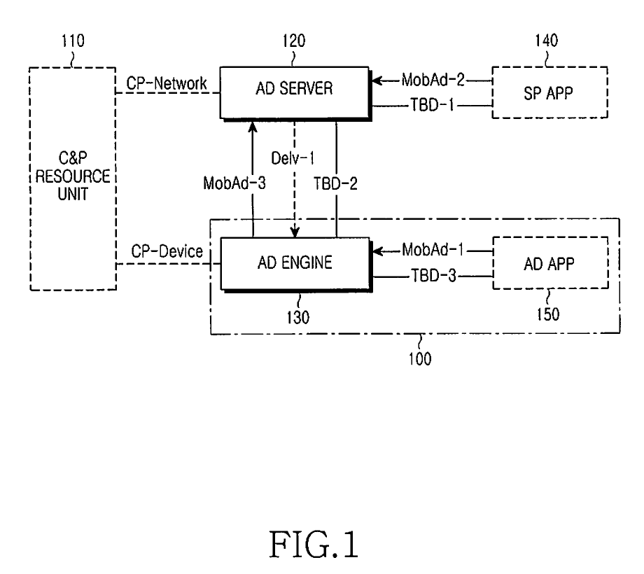

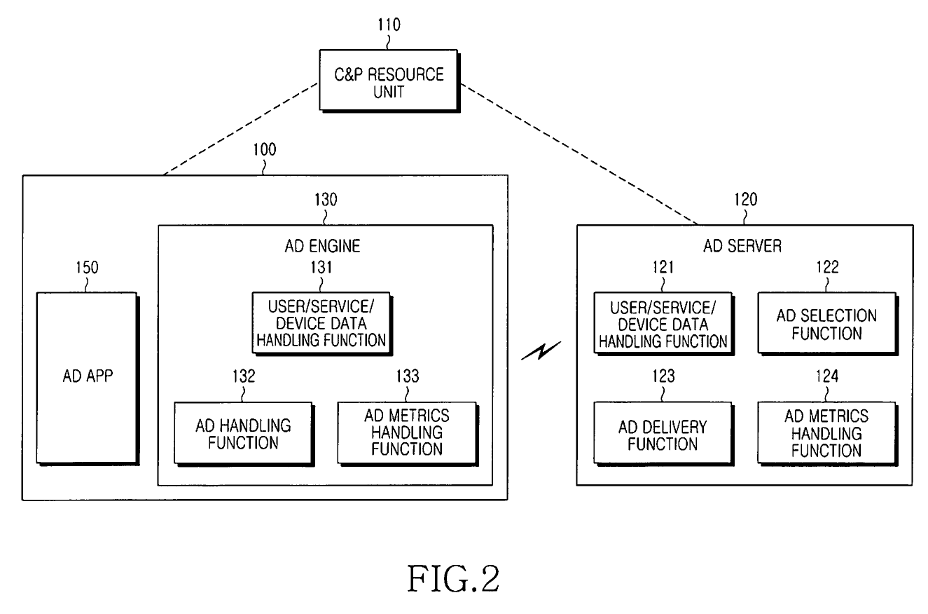

FIG. 1 illustrates a mobile advertising system and interfaces between respective entities, to which the present invention is applied. Further, FIG. 2 illustrates a detailed block diagram of the terminal and the Ad Server illustrated in FIG. 1.

Referring to FIG. 1, a mobile advertising system includes an Ad App 150 and an Ad Engine 130, both being included in an advertisement receiving terminal 100, and an Ad Server 120.

The Ad Engine 130 and the Ad Server 120 provide personalized advertising services to users by referencing/using C & P information from a C & P resource unit 110.

As indicated above, the term “C & P information” refers to information that becomes criteria for advertisement selection and is associated to users or advertisement receiving terminals. In the C & P information, information that does not changes very often can be further classified as personalization information, and information that changes more frequently can be further classified as contextualization information. For example, the personalization information may include ages, family relations, residences, schools, jobs, hobbies and preferences of users, and model numbers and specifications of advertisement receiving terminals. The contextualization information may include, for example, current locations of advertisement receiving terminals, peripheral information regarding the current locations, types of applications being run in advertisement receiving terminals, types and the number of Ad Apps installed in advertisement receiving terminals, current battery levels of advertisement receiving terminals, keywords, etc. The amount of C & P information considered for advertisement selection can vary from a single type of information to several types of information.

The Ad Server 120 selects an advertisement corresponding to the C & P information received from the Ad Engine 130 and provides the selected advertisement to the Ad Engine 130. In accordance with an embodiment of the present invention, the Ad Server 120 provides the Ad Engine 130 with the selected advertisement and the C & P information. However, if there is no advertisement corresponding to the C & P information, the Ad Server 120 may send a default advertisement or ‘no-advertisement’ status information.

The Ad receiving terminal 100, i.e., a mobile terminal receiving mobile advertisements based on a mobile advertising service, may be a mobile phone, PDA, etc. The Ad receiving terminal 100 includes the Ad Engine 130 and at least one Ad App 150.

The Ad App 150 provides an interface between the user and the Ad Engine 130 to enable an advertisement request and keyword entry by the user. Further, the Ad App 150 describes advertisements received from the Ad Server 120 and provides them for the user. That is, the Ad App 150 may replay video advertisements and voice advertisements or display text advertisements according to their type.

The Ad Engine 130 is used to access the Ad Server 120. The Ad Engine 130 includes a plurality of function blocks including logical modules. The Ad Engine 130 interacts with the Ad App 150 making practical application of advertisements, and supports useful functions that the Ad App 150 uses in accessing the mobile advertising service. The Ad Engine 130, as illustrated in FIG. 2, includes an Ad handling function 132, an Ad metrics handling function 133, and a User/Service/Device data handling function 131.

The Ad handling function 132 receives advertisements from the Ad Server 120 and handles the received advertisements. Further, the Ad handling function 132 selects advertisements stored in a cache (not shown) of the terminal, and provides the selected advertisements to the user through the Ad App 150. The Ad handling function 132 handles and applies criteria to be used for advertisement request, receives an advertisement request from the Ad App 150, and provides advertisements corresponding to the advertisement request.

The Ad metrics handling function 133 receives metrics (or interaction results) from the Ad App 150, combines the metrics with information (e.g., a time the metrics were measured) known to the Ad Engine 130, checks and indicates fraudulence of the received metrics, and provides the metrics to the Ad Server 120.

The User/Service/Device data handling function 131 handles dynamic/static information of the user/device, and provides mobile advertising service-related information (e.g., rule and policy). Further, the User/Service/Device data handling function 131 sends a request for C & P information to the C & P resource unit 110, and receives the requested C & P information from the C & P resource unit 110.

The Ad Server 120 illustrated in FIG. 2 is included in a network, and provides advertisements to the Ad Engine 130 and a Service Provider Application (SP App) 140. Like the Ad Engine 130, the Ad Server 120 also includes logical modules. The Ad Server 120 includes an Ad selection function 122, an Ad delivery function 123, an Ad metrics handling function 124, and a User/Service/Device data handling function 121.

The Ad selection function 122 handles data provided from other authorized principals for advertisement selection, compares and filters advertisements determined by given criteria, and selects advertisements determined by the rule and criteria.

The Ad delivery function 123 supports providing advertisement metadata associated with advertisements or advertising campaigns to the Ad Engine 130 and the service provider application 140, and delivering rules including usage of advertisements, and instructions.

The Ad metrics handling function 124 supports collecting impressions of advertisements and user response information, received from the Ad Engine 130 and the service provider application 140, collecting and handling metrics-related information (e.g., information about the time the advertisements were impressed or exposed) and integrating the collected several metrics.

The User/Service/Device data handling function 121 supports handling user contextualization data and MobAd Enabler Service-related data, creating and selecting groups, creating advertising channels, and handling advertisements and advertisement metadata. Further, the User/Service/Device data handling function 121 sends a request for C & P information to the C & P resource unit 110, and receives the requested C & P information from the C & P resource unit 110.

Table 1 below shows interfaces used between the components (or logical entities) illustrated in FIG. 1.

TABLE 1

| Interface | Description |
|---|---|
| TBD-1 | All interfaces between Ad Server and SP App, excluding |
| | MobAd-2 |
| TBD-2 | All interfaces between Ad Server and Ad Engine, excluding |
| | MobAd-3 and Delv-1 |
| TBD-3 | All interfaces between Ad Engine and Ad App, excluding |
| | MobAd-1 |
| MobAd-1 | MobAd-1 is an interface between Ad Engine and Ad App, and |
| | the interface is provided to Ad App by Ad Engine. This |
| | interface is used when Ad App sends a request for |
| | advertisements and advertisement-related identifiers or |
| | provides advertising metrics to Ad Engine. |
| MobAd-2 | MobAd-2 is an interface between Ad Server and SP App, and |
| | the interface is provided to SP App by Ad Server. This |
| | interface is used when SP App sends a request for |
| | advertisements or provides advertising metrics to Ad Server, |
| | or when Ad Server provides advertising identifiers associated |
| | with an advertisement response to SP App. |
| MobAd-3 | MobAd-3 is an interface between Ad Server and Ad Engine, |
| | and the interface is provided by Ad Server to Ad Engine. |
| | This interface is used when Ad Engine sends a request for |
| | advertisements and advertisement-related identifiers or |
| | provides advertising metrics to Ad Server. |
| Delv-1 | Delv-1 is an optional interface provided by Ad Engine, and |
| | Ad Engine receives advertisements and advertisement |
| | metadata over this interface using push and broadcast delivery |
| | devices in its lower entity. Ad Server uses this interface when |
| | delivering advertisements, advertisement notification, and |
| | service notification to Ad Engine. |

Because the Ad Server may reference/use C & P information that is different from the C & P information that the Ad Engine sent with an advertisement request in the prior art, in accordance with an embodiment of the present invention an Ad Server delivers C & P information that it actually referenced/used during advertisement selection and an advertisement to the Ad Engine.

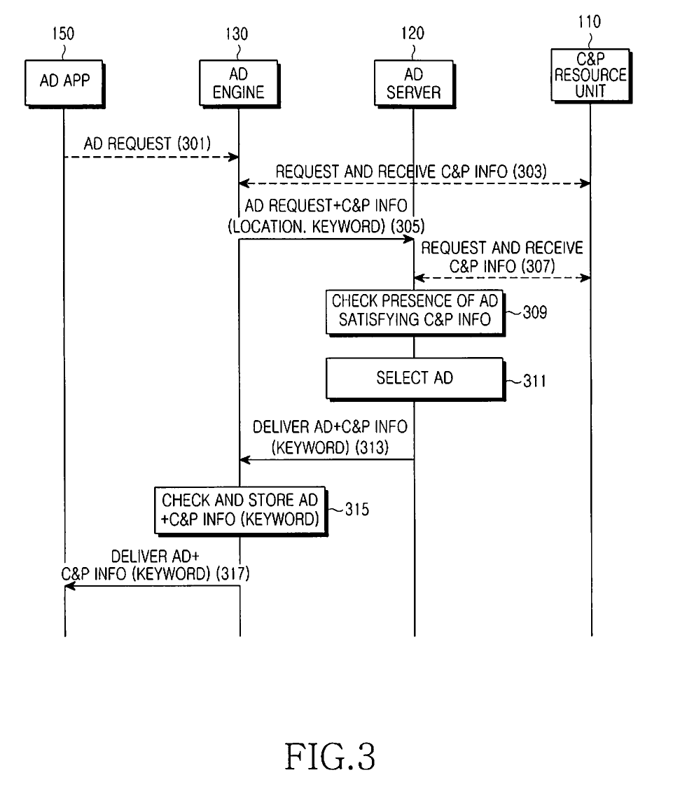

FIG. 3 is a flow diagram illustrating a method for providing and receiving a mobile advertising service in a mobile advertising system according to an embodiment of the present invention.

In step 301, a user of the terminal sends an advertisement request to the Ad Engine 130 through the Ad App 150. Alternatively, Step 301 may also be performed after step 313.

In step 303, the Ad Engine 130 retrieves C & P information of the current user from the C & P resource unit 110 in order to indicate C & P information of the current user. Step 303 is optional. That is, the Ad Engine 130 may send a request for the C & P information to the C & P resource unit 110 when necessary, or may be periodically provided with the C & P information from the C & P resource unit 110. When there is C & P information acquired in step 303, the Ad Engine 130 sends an advertisement request to the Ad Server 120, after applying the C & P information in step 305.

In accordance with this embodiment of the present invention, location information and a keyword are reflected as C & P information.

In step 307, the Ad Server 120, which has received the advertisement request, checks the C & P information reflected in the received request message, and retrieves C & P information of the current user from the C & P resource unit 110, when necessary.

In step 309, the Ad Server 120 determines if there is an advertisement corresponding to the C & P information received in step 307. If there is an advertisement corresponding to the C & P information, the Ad Server 120 selects the advertisement in step 311. However, if there is no advertisement satisfying the C & P information, the Ad Server 120 may provide a default advertisement.

In FIG. 3, when there is no advertisement corresponding to the location and there is an advertisement corresponding to the keyword, the Ad Server 120 selects the advertisement corresponding to the keyword.

Even though there is C & P information received in step 307, if there is no advertisement corresponding to all of the location information and the keyword reflected on the received C & P information and there is an advertisement corresponding to the keyword the Ad Server 120 selects the advertisement corresponding to the keyword.

In step 313, the Ad Server 120 delivers the applied C & P information (keyword in this embodiment) to the Ad Engine 130 with the advertisement selected in step 311. For example, C & P information referenced/used during advertisement selection may be provided in an advertisement response message with an advertisement as shown in Table 2. However, a format of the message is not limited to the example shown in table.

TABLE 2

| Name | Description |
|---|---|
| Ad Request ID | Identifier of advertisement request message, globally |
| | unique |
| Ad App ID | Identifier of Ad App, globally unique |
| Version | Version of advertisement request message. New |
| | version replaces old version |
| User-ID | Identifier of user requesting advertisement |
| Name | Name of user requesting advertisement, expressible in |
| | several languages |
| Advertisement | Requested advertisement |
| C&P Information | Contextualization and Personalization information |
| | referenced/used during advertisement selection |

When the Ad Server 120 delivers the advertisement and the C & P information referenced/used during advertisement selection to the Ad Engine 130, the Ad Server 120 may use a method of leaving only the C & P information actually referenced/used during advertisement selection in a C & P related metadata list of the advertisement or flagging only the C & P information actually referenced/used during advertisement selection in the list, or may check (select) C & P information in the related metadata and response message. However, the present invention is not limited to these methods.

In step 315, the Ad Engine 130 checks the received advertisement and the applied C & P information. If the Ad Engine 130 has pre-fetched an advertisement without a request from the Ad App 150, as in step 301, or intends to provide the same advertisement to the user at a later time, without deletion, the Ad Engine 130 stores the advertisement and the applied C & P information. In step 317, the Ad Engine 130 delivers the received advertisement and C & P information (keyword) to the Ad App 150, thereby providing the advertisement to the user.

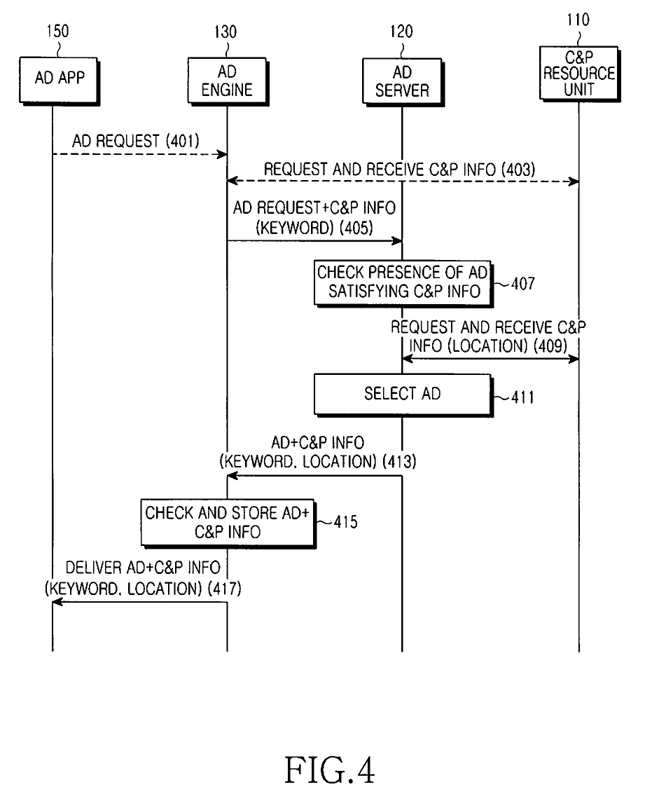

FIG. 4 is a flow diagram illustrating a method for providing and receiving a mobile advertising service in a mobile advertising system according to an embodiment of the present invention.

Steps 401 and 403 of FIG. 4 correspond to steps 301 and 303 of FIG. 3. Accordingly, a description of these steps will not be repeated.

In step 405, the Ad Engine 130 sends an advertisement request to the Ad Server 120, after receiving the C & P information. In this embodiment, keyword is reflected as C & P information.

The Ad Server 120, which has received the advertisement request, checks the C & P information reflected in the request message received in step 405 and determines if there is any advertisement corresponding to the C & P information in step 407. If additional C & P information is needed as there are too many advertisements corresponding to the keyword received from the Ad Engine 130, the Ad Server 120 acquires new C & P information by sending a request for the new C & P information to the C & P resource unit 110 in step 409. In this embodiment, where it is assumed that as there are too many advertisements corresponding to the keyword reflected by the Ad Engine 130, the Ad Server 120 provides an advertisement by additionally using the new C & P information representing location information of the current user.

In step 411, the Ad Server 120 selects an advertisement corresponding to the C & P information acquired in step 403 and the C & P information transmitted in step 405. If there is no advertisement corresponding to the C & P information acquired in step 403 and the C & P information transmitted in step 405, the Ad Server 120 may provide a default advertisement.

In step 413, the Ad Server 120 delivers the location information and keyword, which are the applied to the C & P information, to the Ad Engine 130 together with the advertisement. The delivery method of step 413 is equal to the delivery method of step 313 in FIG. 3, except for the C & P information provided with the advertisement.

In step 415, the Ad Engine 130 checks the received advertisement and the applied C & P information. If the Ad Engine 130 has pre-fetched an advertisement without a request from the Ad App 150, as in step 401, or intends to provide the same advertisement to the user later on, without deletion, the Ad Engine 130 stores the advertisement and the applied C & P information. In step 417, the Ad Engine 130 delivers the received advertisement and the C & P information (keyword and location) to to the Ad App 150, thereby providing the advertisement to the user.

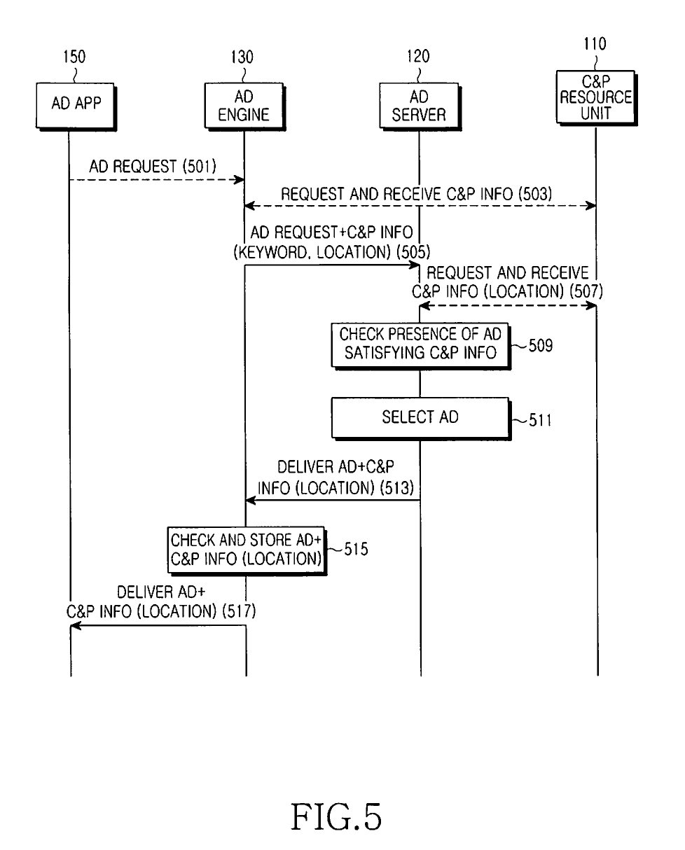

FIG. 5 is a flow diagram illustrating a method for providing and receiving a mobile advertising service in a mobile advertising system according to an embodiment of the present invention.

Steps 501 and 503 correspond to steps 301 and 303 in FIG. 3. Accordingly, a description of these steps will not be repeated.

In step 505, the Ad Engine 130 sends an advertisement request to the Ad Server 120 after applying the C & P information thereto. In this embodiment, a keyword and a location are reflected as the C & P information. In step 507, the Ad Server 120, which has received the advertisement request, retrieves C & P information of the current user from the C & P resource unit 110 to reflect the C & P information of the current user. However, step 507 is optional.

In step 509, the Ad Server 120 checks the C & P information reflected in the received request message, and then determines if there is any advertisement corresponding to all of the C & P information (e.g., the keyword and the location information in this embodiment). If there is no advertisement corresponding to all of the C & P information, the Ad Server 120 selects, in step 511, an advertisement corresponding to part (e.g., the location information in this embodiment) of the C & P information received from the Ad Engine 130. In step 513, the Ad Server 120 delivers the selected advertisement and the part of the C & P information (i.e., the location information) received from the Ad Engine 130, to the Ad Engine 130.

In step 515, the Ad Engine 130 checks the received advertisement and the applied C & P information. If the Ad Engine 130 has pre-fetched an advertisement without a request from the Ad App 150, as in step 501, or intends to provide the same advertisement to the user later on, without deletion, the Ad Engine 130 stores the advertisement and the applied C & P information.

In step 517, the Ad Engine 130 delivers the received advertisement and the part of the C & P information (i.e., the location) to the Ad App 150, thereby providing the advertisement to the user.

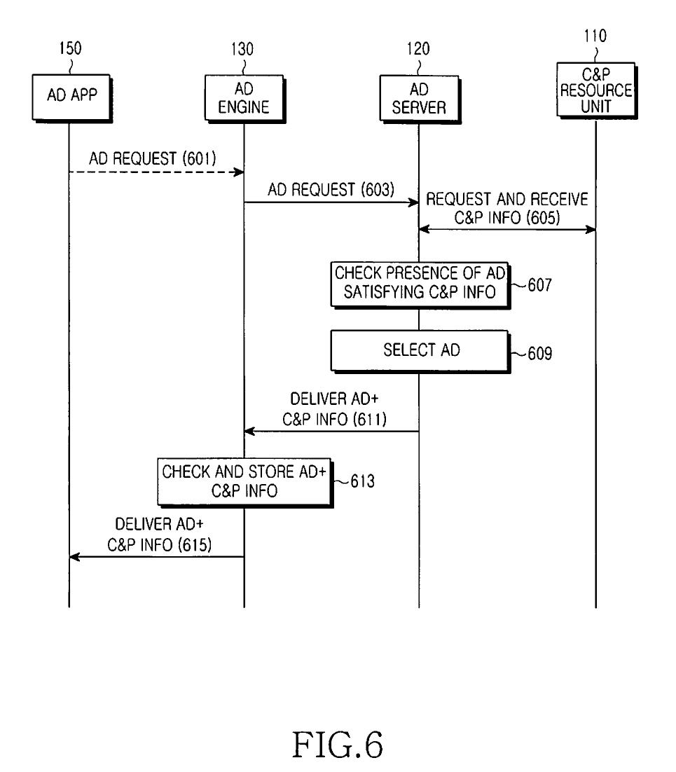

FIG. 6 is a flow diagram illustrating a method for providing and receiving a mobile advertising service in a mobile advertising system according to an embodiment of the present invention.

Step 601 corresponds to step 301 of FIG. 3. Accordingly, a description of this step will not be repeated.

In step 603, the Ad Engine 130 sends an advertisement request to the Ad Server 120 without C & P information. Thereafter, in step 605, the Ad Server 120 sends a request for C & P information to the C & P resource unit 110 and receives the C & P information in response to the request.

In step 607, the Ad Server 120 checks the received C & P information and determines if there is any advertisement corresponding to the C & P information. If there is an advertisement corresponding to the C & P information, the Ad Server 120 selects the advertisement corresponding to the C & P information in step 609. In step 611, the Ad Server 120 delivers the selected advertisement and the C & P information received from the C & P resource unit 110, to the Ad Engine 130.

In step 613, the Ad Engine 130 checks the received advertisement and the C & P information. If the Ad Engine 130 has pre-fetched an advertisement without a request from the Ad App 150 as in step 601, or intends to provide the same advertisement to the user later on, without deletion, the Ad Engine 130 stores the advertisement and the C & P information.

In step 617, the Ad Engine 130 delivers the received advertisement and the C & P information to the Ad App 150, thereby providing the advertisement to the user.

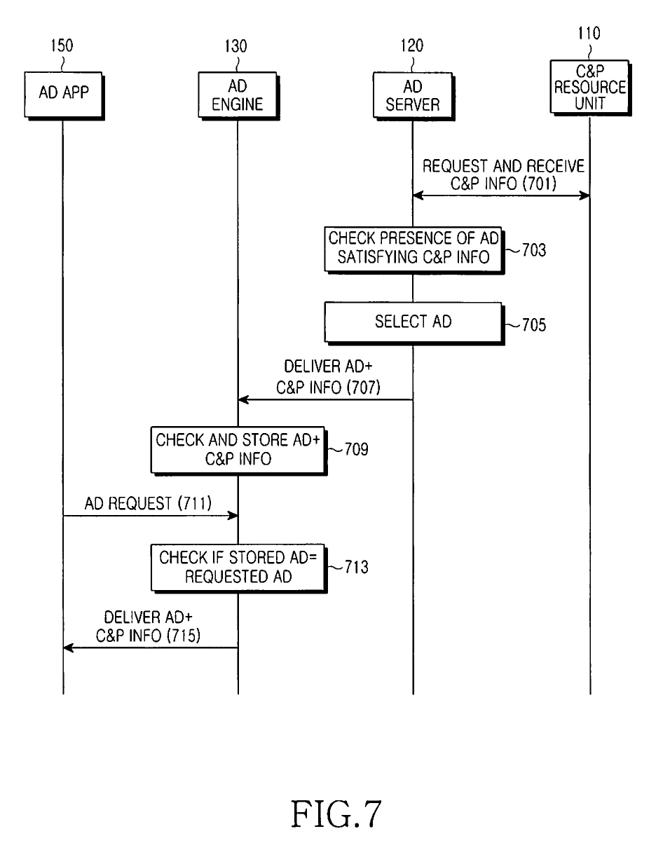

FIG. 7 is a flow diagram illustrating a method for providing and receiving a mobile advertising service in a mobile advertising system according to an embodiment of the present invention.

In step 701, the Ad Server 20 sends a request for C & P information to the C & P resource unit 100 and then receives the C & P information in response to the request. In step 703, the Ad Server 120 checks the received C & P information and determines if there is any advertisement that corresponds to the C & P information. If there is an advertisement that corresponds to the C & P information, the Ad Server 120 selects the advertisement corresponding to the C & P information in step 705. In step 707, the Ad Server 120 delivers the selected advertisement and the C & P information to the Ad Engine 130. The delivery method of step 707 corresponds to step 313 in FIG. 3, except for the C & P information being provided with the advertisement.

In step 709, the Ad Engine 130 checks the received advertisement and the applied C & P information. If the Ad Engine 130 has pre-fetched an advertisement without a request from the Ad App 150, or intends to provide the same advertisement to the user later on, without deletion, the Ad Engine 130 stores the advertisement and the applied C & P information. Thereafter, the Ad App 150 sends an advertisement request to the Ad Engine 130 in step 711. Then the Ad Engine 130 determines, in step 713, whether the advertisement (previously stored advertisement) received in step 709 is identical to the advertisement requested in step 711. If they are identical, the Ad Engine 130 delivers the advertisement and the C & P information to the Ad App 150.

As is apparent from the foregoing description, the above-described embodiments of the present invention enable a user to receive the C & P information that is used for advertisement selection with an advertisement, when receiving an advertisement requested by an Ad Engine and providing the advertisement to the user through an Ad App.

In addition, when there is an intention to later provide an advertisement that was pre-fetched in an Ad Engine or a terminal in response to another advertisement request, the C & P information referenced/used during advertisement selection is provided to the Ad Engine, so that the Ad Engine may provide a proper advertisement requested by the user to the Ad App.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for providing a mobile advertising service in an advertising server of a mobile advertising system, comprising:
receiving, by the advertising server, an advertisement request message and at least one contextualization information from an advertising engine;
selecting, by the advertising server, an advertisement corresponding to at least one contextualization information; and
delivering, by the advertising server, the selected advertisement and the at least one contextualization information used to select the advertisement to the advertising engine.

2. The method of claim 1, wherein, when the at least one contextualization information includes a plurality of contextualization information, selecting the advertisement corresponding to the at least one contextualization information comprises selecting the advertisement corresponding to only a portion of the plurality of contextualization information, when there is no advertisement that corresponds to all of the plurality of contextualization information.

3. The method of claim 1, wherein when there is no advertisement corresponding to the at least one contextualization information, the method further comprises:
acquiring additional contextualization information from a contextualization and personalization resource unit; and
selecting an advertisement that corresponds to the additional contextualization information.

4. The method of claim 1, further comprising selecting a default advertisement, when there is no advertisement corresponding to the at least one contextualization information.

5. The method of claim 1, wherein selecting the advertisement corresponding to the at least one contextualization information comprises:
acquiring additional contextualization information from a contextualization and personalization resource unit; and
selecting the advertisement corresponding to the additional contextualization information and the at least one contextualization information received from the advertising engine.

6. The method of claim 1, wherein the at least one contextualization information used to select the advertisement includes the at least one contextualization information from an advertising engine or at least one different contextualization information.

7. The method of claim 1, wherein delivering the selected advertisement comprises:
flagging only information from among the at least one contextualization information used for selecting the advertisement from a contextualization information related metadata list of the selected advertisement; and
delivering the metadata list of the selected advertisement including the flagged in formation.

8. The method of claim 1, wherein delivering the selected advertisement comprises delivering only information from among the at least one contextualization information used for selecting the advertisement from a contextualization information related metadata list of the selected advertisement.

9. A method for providing a mobile advertising service in an advertising server of a mobile advertising system, comprising:
receiving, by the advertising server, an advertisement request message from an advertising engine;
acquiring, by the advertising server, at least one contextualization information from a contextualization and personalization resource unit;
selecting, by the advertising server, an advertisement corresponding to the at least one contextualization information; and
delivering the selected advertisement and the at least one contextualization information used to select the advertisement to the advertising engine.

10. A method for receiving a mobile advertising service in an advertising engine of a mobile advertising system, comprising:
sending, by the advertising engine, an advertisement request message and at least one contextualization information to an advertising server; and
receiving, by the advertising engine, a selected advertisement and contextualization information used to select the advertisement, when an advertisement corresponding to the at least one contextualization information is selected by the advertising server.

11. The method of claim 10, further comprising storing, by the advertising engine, the received advertisement and the contextualization information used to select the advertisement.

12. The method of claim 10, further comprising providing, by the advertising engine, the selected advertisement to a user by delivering the received advertisement and the contextualization information used to select the advertisement to an advertising application.

13. An apparatus for receiving a mobile advertising service in an advertising engine of a mobile advertising system, comprising:
an advertisement handling unit for sending an advertisement request message and contextualization and personalization information to an advertising server, and receiving a selected advertisement and contextualization and personalization information used to select the advertisement, when an advertisement corresponding to the contextualization and personalization information is selected by the advertising server.

14. The apparatus of claim 13, wherein the advertisement handling unit stores the received advertisement and the contextualization information used to select the advertisement.

15. The apparatus of claim 13, further comprising a data handling unit for sending a request message for the contextualization and personalization information to a contextualization and personalization resource unit, and for acquiring the contextualization and personalization information corresponding to the request message from the contextualization and personalization resource unit.
